(19) United States
(12) Patent Application Publication
(10) Pub. No.: US 2025/0259768 A1
(43) Pub. Date: Aug. 14, 2025

(54) HOT-STICKABLE DISK

(71) Applicant: Hubbell Incorporated, Shelton, CT (US)

(72) Inventors: Paul Alfaro, Orange, CA (US); Joseph Paul Alfaro, Artesia, CA (US)

(21) Appl. No.: 19/050,635

(22) Filed: Feb. 11, 2025

Related U.S. Application Data
(60) Provisional application No. 63/552,424, filed on Feb. 12, 2024.

(51) Int. Cl. H01B 17/24; H02G 1/02

(52) U.S. Cl. CPC H01B 17/24; H02G 1/02

(57) ABSTRACT

A barrier for use in an electrical system includes a body and a channel. The body has an outer perimeter and an inner perimeter that forms an aperture which can receive a support. The aperture is formed in a center of the body. A channel extends through the body between the outer perimeter and the inner perimeter. A center of mass (COM) of the body is located along the channel a first distance away from the center of the body.

### CROSS-REFERENCE TO RELATED APPLICATION

This application claims the benefit of U.S. Provisional Patent Application No. 63/552,424, filed Feb. 12, 2024, the entire contents of which are incorporated herein by reference in its entirety.

### FIELD

The present disclosure relates to a barrier for limiting access to energized elements. More particularly, the present disclosure relates to eccentric barrier that resists decoupling in extreme environmental conditions.

### BACKGROUND

Electrical components (e.g., power lines and other energized elements) are built across different environments to bring power to consumers and businesses. To convey electrical energy to consumers across wide and diverse areas, energized components need to be built within many environments, some of may be undeveloped or otherwise include an abundance of wildlife. Wildlife may be interested in these structures and not realize the dangers posed by the energized elements.

To keep the wildlife safe, linesman or other technicians may install guards at or near the energized elements. These guards may assist in providing a barrier between the animals' habitat and the energized elements, thereby reducing the animals that are inadvertently harmed. The guards also help to maintain the integrity of the system by limiting shorts or other electrical failures caused when animals interact with the energized elements.

The guard (e.g., a barrier disc) can be a simple (1 step installation) hot stick application. Installation may also occur with a tool (e.g., a shotgun tool) by pushing or pulling the component on the equipment. The guard can also be installed via rubber glove work method (e.g., manually).

Some environments where guards are installed may produce high winds, which can cause the guard to rotate. Rotating bodies experience a centrifugal force, which is a force directed radially outwardly from a body's center of mass.

The guards typically include a pathway to insert the guard around its supporting element. As the guard rotates, the centrifugal force may at times be directed in an opposite direction from the pathway. In mild conditions, the guard may be capable of resisting the centrifugal force (e.g., via a frictional force). However, in high winds, the centrifugal force may exceed any other forces and may cause the guard to decouple from its support, which enables wildlife to access potentially dangerous areas.

Additional components to secure the pathway could be hot stick or shotgun installed. Although technicians can attempt to secure the pathway closed (e.g., with a zip tie) this may be an imperfect and impractical method to keep the guard secured. Securing the pathway adds additional steps, components, and effort, which may increase labor and/or material costs. Additionally, the body of the guard may be flexed to fit around a support and overtightening the guard after it is received around the support may cause it to fracture. Alternatively, while simply closing an opening to the pathway may initially limit the guard from becoming disconnected, the guard may still decouple because of the centrifugal force and ride along the technician's fastener, which can also fail.

A need for a way to ensure that a guard will remain coupled to its support during various environmental conditions is needed to limit failure of the guards and ensure that wildlife remains protected.

### SUMMARY

Various examples of the present disclosure can overcome various of the aforementioned and other disadvantages associated with known guards and offer new advantages as well.

According to one aspect of various examples of the present disclosure there is provided an eccentric body having a center of mass spaced apart from a centroid.

According to one aspect of various examples of the present disclosure there is provided an eccentric body having a central opening and a channel. A center of mass of the body is located along the channel.

According to one aspect of various examples of the present disclosure there is provided an eccentric body having an asymmetric body with a first half that has a channel and a second half that lacks a channel. A center of mass of the body is located within the first half of the body and spaced apart from a geometric center.

According to another aspect of various examples of the present disclosure, there is provided a barrier for use in an electrical system. The barrier includes a body and a channel. The body has an outer perimeter and an inner perimeter that forms an aperture which can receive a support. The aperture is formed in a center of the body. A channel extends through the body between the outer perimeter and the inner perimeter. A center of mass (COM) of the body is located along the channel a first distance away from the center of the body.

According to another aspect of various examples of the present disclosure, there is provided a barrier for use in an electrical system. The barrier includes a body and a channel. The body has an outer perimeter and an inner perimeter that forms an aperture which can receive a support. The aperture is formed in a center of the body. A channel extends through the body between the outer perimeter and the inner perimeter. A center of mass (COM) of the body is located proximate to the channel a first distance away from the center of the body.

According to another aspect of various examples of the present disclosure, there is provided a barrier for use in an electrical system. The barrier includes a body and a channel. The body includes an outer perimeter and an inner perimeter. The inner perimeter forms an aperture that can receive a support. A first axis passes through a center of the body and delineates a first region of the body and a second region of the body. A channel extends through the body between the outer perimeter and the inner perimeter. The channel is disposed in the first region. The first region includes a first mass and the second region includes a second mass less than the first mass such that the center of mass (COM) is located in the first region.

According to another aspect of various examples of the present disclosure, there is provided a barrier for use in an electrical system. The barrier includes a body, an aperture, a channel, and a support section. The body is formed from a plurality of spaced apart first ribs. The aperture is formed at a geometric center of the body. The channel extends from the aperture to an outer perimeter of the body. The support section is disposed proximate to the channel and includes an opening that can receive a tool for connecting the body to the support. The support section includes a plurality of spaced apart second ribs. The second ribs are oriented in a denser pattern than the first ribs. The center of mass (COM) of the body is spaced apart from the geometric center in the direction of the support section.

According to another aspect of various examples of the present disclosure, there is provided a barrier for use in an electrical system. The barrier includes a body formed from a plurality of spaced apart first ribs, an aperture formed at a center of the body, and a channel extending from the aperture to an outer perimeter of the body. The body includes a first inner wall and a second inner wall that together at least partially form a boundary of the channel. The body is movable between a first position wherein the first inner wall and the second inner wall are spaced apart by a first distance and a second position where the first inner wall and the second inner wall are spaced apart by a second distance greater than the first distance. A center of mass (COM) of the body is located along the channel and is spaced apart from the center of the body.

According to another aspect of various examples of the present disclosure, there is provided a method of reducing wildlife disturbances. The method includes attaching a guard to a support to block access from wildlife. The guard includes a channel that can receive the support, and a center of mass of the guard is spaced apart from the centroid. The guard can rotate around the support with the application of an external force and a centrifugal force acts to maintain the guard coupled to the support.

According to another aspect of various examples of the present disclosure, there is provided a method of mounting a guard to an electrical support to limit access from wildlife, the method including positioning a tool through an opening in a body of the guard; maneuvering a channel of the body at least partially around an electrical support; wherein the center of mass of the body is disposed within the channel and spaced apart from the centroid.

According to another aspect of various examples of the present disclosure, there is provided a method of mounting a guard to an electrical support to limit access from wildlife, the method including positioning a tool through an opening in a body of the guard; maneuvering a channel of the body at least partially around an electrical support; wherein the center of mass of the body is disposed proximate to the channel and spaced apart from the centroid.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompany drawing wherein:

FIG. 1 is a perspective view of a disk guard.

FIG. 2 is a top view of the disk guard of FIG. 1.

FIG. 3 is a schematic view of the disk guard of FIG. 1 illustrating a centroid and center of mass.

FIG. 4 is a schematic view of an external force acting on the disk guard of FIG. 1.

FIG. 5 is a schematic view of the disk guard of FIG. 1 of a centrifugal force acting in response to the external force

### DETAILED DESCRIPTION

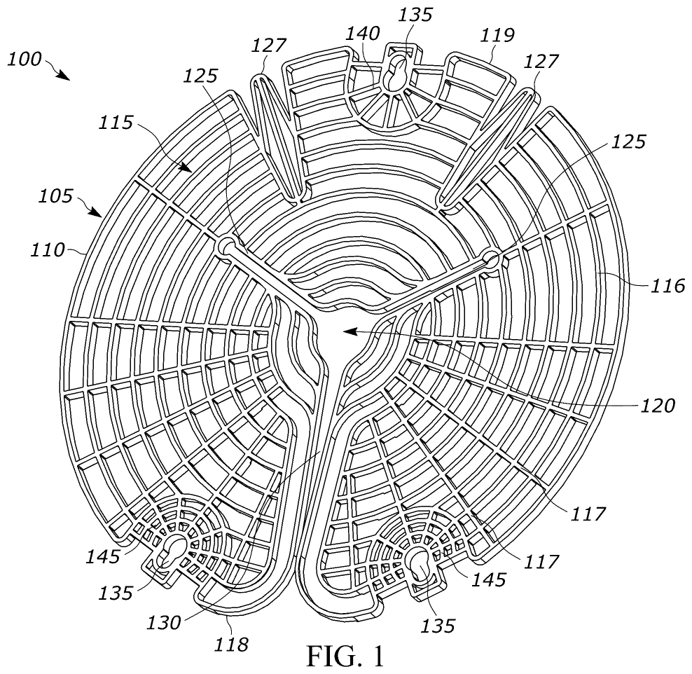

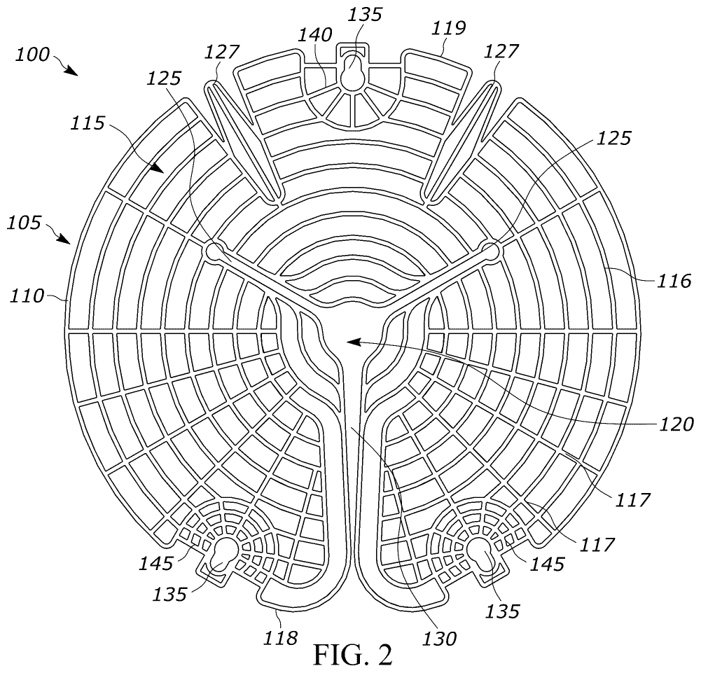

FIGS. 1 and 2 illustrate one example of a guard or barrier 100 according to the present disclosure. The guard 100 includes a body 105 that is illustrated as having a substantially circular shape (e.g., a substantially circular outer perimeter 110). However, other examples of the guard 100 may include a body with a different shape (e.g., elliptical, triangular, rectangular, etc.).

In some forms, the body 105 may not be fully solid and may include a webbed region 115, which may be made up of circumferentially extending webs 116. For example, the webs 116 in the webbed region 115 may be disposed radially inside of the outer perimeter 110 and may include a similar shape (e.g., circular) as the outer perimeter 110.

In certain forms, the circumferential webs 116 may be substantially equally spaced from one another in the radial direction, although in other examples the webs 116 may have unequal spacing. A void may exist between adjacent webs 116 in the radial direction, which may permit airflow to pass through the body 105.

In some forms, the webbed region 115 may further include radial webs 117 that extend along a radial direction of the body 105. For example, the radial webs 117 may extend from the outer perimeter 110 toward the center, although the radial webs 117 may extend along any length of the circumferential direction.

In certain forms, at least some of the radial webs 117 may be unequally spaced around the circumference of the body 105. For example, the spacing of the radial webs 117 on the first half 118 of the body 105 may have a different spacing than the radial webs 118 on a second half of the body 119. The illustrated example includes radial webs 117 that are equally spaced relative to the other radial webs 117 on the same half 118, 119 of the body 105, although other examples may include unequal spacing throughout the entire body 105.

With continued reference to FIGS. 1 and 2, the webbed region 115 may radiate outwardly from a center of the body 105. The center may include an aperture 120, which as described in more detail below, may receive an electrical component or support. These terms may be used throughout to designate any element that the guard is coupled to (e.g., a bushing, a conductor, an insulator, a non-energized structure supporting energized components, etc.). A center point of the aperture 120 may represent a geometric center or centroid of the body 105.

In some forms, one or more channels 125 (e.g., two shown) may extend outwardly in the radial direction from the aperture 120. The illustrated channels 125 are each formed on the second half 119 of the body 105, although any configuration (e.g., one or more on the first half 118) may be constructed.

In certain forms, each channel 125 may be formed as an elongated section that extends in the radial direction outwardly from the aperture 120. The end of each channel 125 may include a rounded region (e.g., substantially circular in shape) that may be wider than the remainder of the respective channel 125.

In one form, a radial web 117 may extend between a channel 125 and the outer perimeter 110. Although in other examples, the radial web 117 and the channel 125 may be spaced apart from one another in the circumferential direction.

The body 105 may also include an insertion pathway 130. Like the channels 125, the insertion pathway 130 may extend outwardly in the radial direction from the aperture 120. The illustrated insertion pathway 130 may be formed on the first half 118 of the body 105.

In some forms, the channels 125 and the insertion pathway 130 may be similar. For example, they may each provide an opening within the body 105 (e.g., through which air or objects may pass) that extends in the radial direction from the aperture 120. In some forms, the channels 125 and the insertion pathway 130 may be equally spaced (e.g., about 120° apart), although in other example, there may be different (e.g., unequal spacing).

In certain forms, the insertion pathway 130 may differ from the channels 125 because the insertion pathway 130 may extend to the outer perimeter 110 and provide a pathway to reach the aperture in the radial direction of the body 105. The other perimeter 110 may therefore not form a closed perimeter.

The body 105 may be constructed from an at least partially flexible material. The guard 100 illustrated in FIGS. 1 and 2 may show the body 105 in a neutral position. For example, walls forming the insertion pathway 130 may extend toward one another and eventually contact one another proximate to the outer perimeter 110. However, as described in more detail later, the body 105 may flex so that the distance between the walls increases and the insertion pathway 130 widens.

The body 105 may include one or more holes 135 (e.g., three shown) proximate to the outer perimeter 110. As described in more detail below, a tool (e.g., a hot-stick-not shown) may be inserted into one of the holes 135 to manually position the guard 100 around a support.

As described above, the first half 118 may differ from the second half 119 of the body 105 because there is a greater concentration of ribs 116, 117 in the first half 118 than in the second half 119. Similarly, the holes 135 may differ based on their positioning on the body 105.

For example, the illustrated body 105 includes two holes 135 on the first half 118 and one hole 135 on the second half 119, although any number or configuration may be used. The holes 135 may be surrounded by a support section, which may have a different shape depending on the location on the body 105.

For example, the hole 135 on the second half 119 may include a support section 140 having a first weight and each hole 135 on the first half 118 may include a support section 145 with a second weight. In some forms, the support section 140 may include a first number of webs, and the support section 145 may include a second number of webs that is greater than the first number. The increased number of webs may make each support section 145 heavier than the support section 140. The first support section 140 is illustrated as being substantially opposite each of the support sections 145, and may be disposed at least about 90° apart so that the support section 140 is disposed on an opposite half of the body 105 from the support sections 145.

In certain forms, the webs of the support section 145 may be more densely positioned than the webs 116, 117 of the webbed region 115 on the first half 118. Although in other examples, support section 145 and the webbed region 115 on the first half 118 could have substantially the same density of webs.

In other examples, the support section 145 may not include any webs and may be a solid region around the respective hole 135. In this instance, the support section 140 may include the webs (e.g., as shown in FIG. 2) or may also be a solid region disposed around the hole 135. In either case, each support section 145 may be constructed so that it is more massive than the support section 140.

In still other examples, the first weight and second weight may be equal. The first half 118 of the body 105 may include a greater mass than the second half 119 because there are more support sections 145 than support sections 140 and/or because there are more webs 116, 117 on the first half 118.

In still further examples, substantially all the first half 118 may be solid and at least some second half 119 may be open to allow for airflow through the body 105. This example may also make the first half 118 more massive than the second half 119.

In still further examples, the first half 118 may be constructed from a first material and the second half 119 may be constructed from a second material (e.g., two materials are introduced into a mold). The first material may be denser than the second material, which may make the first half 118 more massive than the second half 119.

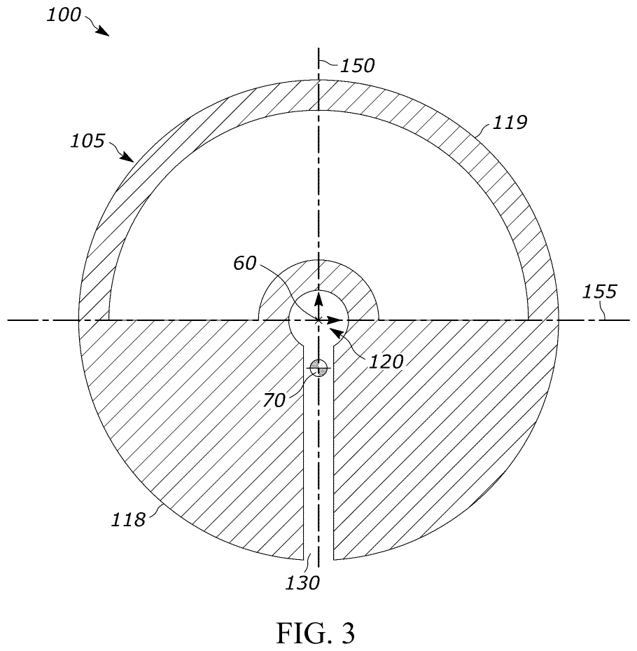

As shown in FIG. 3, the guard 100 may be positioned so that a support 50 is received within the aperture 120. Coupling the guard 100 to the support 50 may involve using a tool (e.g., a hot-stick-not shown) to position the guard 100 without touching the support 50. The tool may be removable coupled to the guard 100 via at least one of the holes 135. The tool can move (e.g., push or pull) the guard to the support 50 and adjust the insertion pathway 130 (e.g., move the body 105 from a neutral position to a second position) to accommodate the support 50. In the second position, the walls of the insertion pathway 130 may be moved against a bias toward the neutral position (see e.g., FIG. 2) to form a wider area. In some forms, the walls of the aperture 120 may provide a clamping force against the support as the insertion pathway 130 attempts to return to the neutral position. Although not shown, the channels 125 may also widen as the insertion pathway moves away from the neutral position to accommodate the support 50.

In some forms, the body 105 may include at least one compressive region 127 (e.g., two shown in FIGS. 1 and 2). The compressive regions 127 may be disposed substantially opposite of the insertion pathway 130. The compressive regions 127 may permit the body 105 to compress around that location to permit the insertion pathway 130 to widen.

As shown in FIGS. 1 and 2, the support section 140 may be disposed between the compressive regions 127. Each compressive region 127 may include a wider middle section and a narrower outer section (e.g., proximate to the other perimeter 110). The outer perimeter 110 of the body 105 may also be discontinuous on either side of each compressive region 127. When a force is applied to the body 105 to expand the width of the insertion pathway 130 (e.g., expand from a neutral position), the discontinuous sections of the outer perimeter 110 on either side of a respective compressive region 127 may move proximate to one another is the middle section of the compressive region 127 flattens out and decreases in width.

Returning to FIG. 3, the guard 100 may have a geometric center or centroid 60 in a center of the body 105 (e.g., in a center of the aperture 120). A center of mass 70 of the guard 100 may be spaced apart from the geometric center 60. In the illustrated example, the center of mass 70 may be located in the first half 118 of the body 105. Specifically, the center of mass 70 may be located along the insertion pathway 130 (e.g., along the center of the insertion pathway 130, although other locations of the center of mass 70 may be used). For example, other forms may include a center of mass located a certain distance (e.g., 0.25 inches, 0.5 inches, 1 inch, etc.) on either side of the insertion pathway while remaining in the first half 118 of the body 105.

In some examples, the center of mass 70 may be between about 0.01 inches and about 10 inches away from the geometric center 60 in the radial direction. In some examples, the center of mass 70 may be between about 0.05 inches and about 8 inches away from the geometric center 60 in the radial direction. In some examples, the center of mass 70 may be between about 0.1 inch and about 5 inches away from the geometric center 60 in the radial direction. In some examples, the center of mass 70 may be between about 0.25 inches and about 4 inches away from the geometric center 60 in the radial direction. In some examples, the center of mass 70 may be between about 0.5 inches and about 2 inches away from the geometric center 60 in the radial direction. In some examples, the center of mass 70 may be about 1 inch away from the geometric center 60 in the radial direction.

In some examples, the center of mass 70 may be located in the first half 118 any distance away from the geometric center 60 that is at least about 1 inch (e.g., 1 inch, 1.5 inches, 2 inches, etc.).

In other forms, the distance between the center of mass 70 and the geometric center 60 may be measured along a pathway axis 150. For example, the center of mass 70 may be positioned at any location with a negative coordinate (e.g., as viewed in FIG. 3) along the pathway axis 150 (i.e., in the first half 118 of the body 105). The center of mass 70 may therefore have a non-zero coordinate along the transverse axis 155. The radial distance between the center of mass 70 and the geometric center may therefore be greater than the distance between the center of mass 70 and the geometric center 60 may be measured along a pathway axis 150. For example, the center of mass 70 may be about 1 inch away from the geometric center 60 as measured along the pathway axis 150, and may be further than 1 inch away from the geometric center 60 as measured along the radial direction. In this situation, the first half 118 may be asymmetric about the pathway axis 150 so that the center of mass 70 includes a non-zero coordinate along the transverse axis 155 (e.g., the body 105 includes only one support section 145).

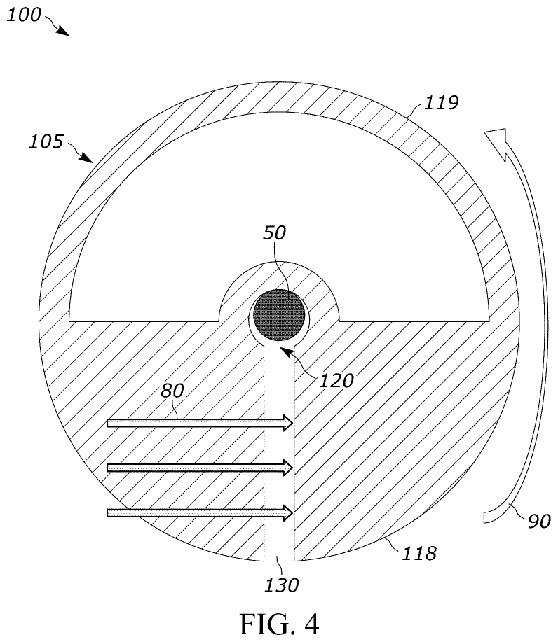

In use, an external force 80 may act on the guard 100. For example, the guard may be installed in places that experience high winds (e.g., up to and/or exceeding about 80-90 mph) that exert a force on the guard 100. As illustrated in FIG. 4, the external force 80 (e.g., wind force) may act proximate to the outer perimeter 110, which creates a torque sufficient to cause rotation 90. In windy environments, the guard 100 may rotate about the support 50.

When an object moves in a circular path, a centrifugal force acts on the body in a direction away from the center of rotation. Because the body 105 has an opening (e.g., the insertion path 130), body 105 should be designed so that the centrifugal force does not cause the guard 100 to disconnect from the support 50 in windy conditions.

To achieve this, the body 105 is manufactured with a greater mass on the first half 118 than on the second half 119. As described above, this may be achieved through a greater density of webs 116, 117, by more massive support sections 145, and/or by a greater number of support sections 145 in the first half 118 as compared to the second half 119. More specifically, the section of the body 105 proximate to the insertion path 130 is more massive than the opposite section.

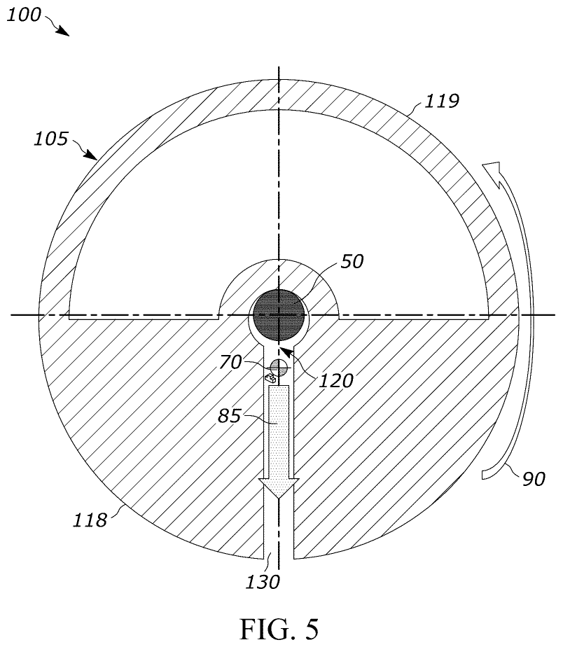

As shown in FIG. 5, the centrifugal force 85 acts outwardly from the center of mass 70 along the insertion path 130. For example, the first half 118 of the body 105 may be substantially symmetrical about the insertion pathway 130 so that the center of mass is oriented substantially in the center of the insertion pathway 130.

Positioning the center of mass away from the centroid and within the insertion pathway 130 always orients the centrifugal force in a radial direction along the insertion pathway 130 toward the outer perimeter 110.

This force draws the wall of the aperture 120 into the support. In other words, the centrifugal force 85 forces the body 105 into contact with the support 50 and prevents the support from traveling down the insertion path 130. Because the centrifugal force 85 is always directed outwardly, the body 105 will remain in this position as it continues to rotate about the support 50.

In some forms, the center of mass 70 may be at least about 1 inch away from the geometric center 60 to provide sufficient stability on the support 50. For example, a centrifugal force acting at about 1 inch from the geometric center 60 may be sufficient to retain the body 105 on the support 50. A centrifugal force that acts further than 1 inch away from the center (e.g., because the center of mass 70 is more than 1 inch away) may still provide a greater force while also needed more material, while a centrifugal force acting less than 1 inch may not provide sufficient force to retain the body 105. Although these numbers may represent the optimized values for this specific guard 100, changing the dimensions of the guard 100 (e.g., a guard 100 with a larger or smaller diameter) can change when the optimized center of mass 70 is located.

Orienting the center of mass along the insertion pathway 130 also helps to ensure that the centrifugal force is not directed into a wall, which could create frictional forces and limit the ability of the guard to rotate.

Additionally, no additional fasteners are needed to secure the body 105 to the support 50. The centrifugal force, and any clamping forces supplied by the walls of the aperture 120 resulting from the bias of the body 105 toward the neutral position, are sufficient to retain the body 105 coupled to the support 50.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

What is claimed is:

1. A barrier for use in an electrical system, the barrier comprising:
a body having an outer perimeter and an inner perimeter forming an aperture configured to receive a support, the aperture formed in a center of the body; and
a channel extending through the body between the outer perimeter and the inner perimeter;
wherein a center of mass (COM) of the body is located along the channel a first distance away from the center of the body.

2. The barrier of claim 1, wherein the body includes radial ribs that extend at least partially between the outer perimeter and the inner perimeter, wherein the body includes a greater density of radial ribs proximate to the channel.

3. The barrier of claim 2, wherein the body further includes circumferential ribs spaced around the body, and wherein the circumferential ribs are equally spaced from one another in a radial direction.

4. The barrier of claim 1, wherein the body includes an opening spaced apart from the aperture and proximate to the outer perimeter, the opening is configured to receive a tool for maneuvering the body onto the support.

5. The barrier of claim 4, wherein the body further includes a support section at least partially surrounding the opening, wherein the support section is located proximate to the channel and includes a mass greater than surrounding sections of the body.

6. The barrier of claim 1, wherein the body includes a first inner wall and a second inner wall that together at least partially form a boundary of the channel, wherein the body is movable between a first position wherein the first inner wall and the second inner wall are spaced apart by a first distance and a second position where the first inner wall and the second inner wall are spaced apart by a second distance greater than the first distance.

7. A barrier for use in an electrical system, the barrier comprising:
a body including,
an outer perimeter,
an inner perimeter forming an aperture configured to receive a support, and
a first axis passing through a center of the body and delineating a first region of the body and a second region of the body; and
a channel extending through the body between the outer perimeter and the inner perimeter, wherein the channel is disposed in the first region;
wherein the first region includes a first mass and the second region includes a second mass less than the first mass such that the center of mass (COM) is located in the first region.

8. The barrier of claim 7, wherein the body further includes,
an opening spaced apart from the aperture and proximate to the outer perimeter, the opening configured to receive a tool for maneuvering the body onto the support; and
a support section at least partially surrounding the opening, wherein the support section is located in the first region and includes a third mass greater than surrounding sections of the body.

9. The barrier of claim 8, wherein the opening is a first opening and the support section is a first support section, the body further includes,
a second opening spaced apart from the aperture and proximate to the outer perimeter, the second opening configured to receive the tool for maneuvering the body onto the support; and
a second support section at least partially surrounding the second opening, wherein the second support section is located in the second region and includes a fourth mass that is less than the third mass.

10. The barrier of claim 8, wherein the opening is a first opening and the support section is a first support section, the body further includes,
a second opening spaced apart from the aperture and proximate to the outer perimeter, the second opening configured to receive the tool for maneuvering the body onto the support; and
a second support section at least partially surrounding the second opening, wherein the second support section is located in the first region and includes a fourth mass that is greater than surrounding sections of the body;
wherein the first support section and the second support section are disposed symmetrically about the channel.

11. The barrier of claims 7, wherein the body includes a plurality of spaced apart radial ribs that each extend at least partially between the inner perimeter and the outer perimeter, and wherein the density of radial ribs in the first region is greater than the density of radial ribs in the second region.

12. The barrier of claim 7, wherein the body includes a second axis that extends along a center of the channel and is oriented perpendicularly to the first axis, and wherein the COM is located along the second axis.

13. The barrier of claim 7, wherein the body includes a first inner wall and a second inner wall that together at least partially form a boundary of the channel, wherein the body is movable between a first position wherein the first inner wall and the second inner wall are spaced apart by a first distance and a second position where the first inner wall and the second inner wall are spaced apart by a second distance greater than the first distance.

14. The barrier of claim 7, wherein the body is formed from a plurality of spaced apart ribs that are configured to permit airflow through the body.

15. A barrier for use in an electrical system, the barrier comprising:
a body formed from a plurality of spaced apart first ribs;
an aperture formed at a geometric center of the body;
a channel extending from the aperture to an outer perimeter of the body; and
a support section disposed proximate to the channel and including an opening configured to receive a tool for connecting the body to the support, the support section including a plurality of spaced apart second ribs;
wherein the second ribs are oriented in a denser pattern than the first ribs; and
wherein a center of mass (COM) of the body is spaced apart from the geometric center in the direction of the support section.

16. The barrier of claim 15, wherein the support section is a first support section and the opening is a first opening, the support section further comprising:
a second support section disposed proximate to the channel and including a second opening configured to receive the tool for connecting the body to the support, the second support section including a plurality of spaced apart third ribs; and
wherein the COM is disposed between the first support section and the second support section.

17. The barrier of claim 15, wherein the support section is a first support section and the opening is a first opening, the support section further comprising:
a second support section disposed greater than 90° apart from the first support section and including a second opening configured to receive the tool for connecting the body to the support, the second support section including a plurality of spaced apart third ribs; and
wherein the COM is disposed closer to the first support section than the second support section.

18. The barrier of claim 15, wherein the body includes a first inner wall and a second inner wall that together at least partially form a boundary of the channel, wherein the body is movable between a first position wherein the first inner wall and the second inner wall are spaced apart by a first distance and a second position where the first inner wall and the second inner wall are spaced apart by a second distance greater than the first distance.

19. The barrier of claim 15, wherein the COM is located along a first axis that pass through the geometric center and a center of the channel.

20. The barrier of claim 19, wherein a second axis perpendicular to the first axis passes through the geometric center and delineates a first region of the body and a second region of the body, wherein there is a greater number of first ribs in the first region than in the second region.

21.-24. (canceled)
